(19) United States
(12) Patent Application Publication
(10) Pub. No.: US 2018/0038994 A1
(43) Pub. Date: Feb. 8, 2018

(54) Techniques to Improve Global Weather Forecasting Using Model Blending and Historical GPS-RO Dataset

(71) Applicant: International Business Machines Corporation, Armonk, NY (US)

(72) Inventors: Hendrik F. Hamann, Yorktown Heights, NY (US); Siyuan Lu, Yorktown Heights, NY (US)

(21) Appl. No.: 15/226,372

(22) Filed: Aug. 2, 2016

(51) Int. Cl. G01W 1/10; G01W 1/06

(52) U.S. Cl. CPC G01W 1/10; G01W 1/06

(57) ABSTRACT

Techniques for improving weather forecasting using model blending and historical global positioning system-radio occultation (GPS-RO) measurements are provided. In one aspect, a method for weather forecasting includes: obtaining historical GPS-RO measurements; determining a refractive index of the atmosphere from the GPS-RO measurements; obtaining historical forecasts from multiple individual numerical weather models from a same given time period as the GPS-RO measurements; statistically correcting the historical forecasts using the refractive index of the atmosphere determined from the GPS-RO measurements; blending the numerical weather models using the statistically corrected historical forecasts to create a blended weather model, wherein the blending is performed to improve a forecast of the refractive index of the atmosphere by the blended weather model; and forecasting primary weather parameters using the blended weather model. Secondary weather parameters (e.g., wind speed and/or precipitation) can then be forecasted using the primary weather parameters by physical or statistical methods.

### FIELD OF THE INVENTION

The present invention relates to weather forecasting, and more particularly, to techniques for improving weather forecasting using model blending and historical global positioning system-radio occultation (GPS-RO) measurements.

### BACKGROUND OF THE INVENTION

Global positioning system-radio occultation (GPS-RO) is a technique for profiling the state of the atmosphere as a function of vertical height (called a sounding measurement). See, for example, Hajj et al., “A technical description of atmospheric sounding by GPS occultation,” Journal of Atmospheric and Solar-Terrestrial Physics, vol. 64, Issue 4, pgs. 451-469 (March 2002), the contents of which are incorporated by reference as if fully set forth herein. With GPS-RO, GPS satellites in high orbit send microwave GPS signals which pass through the atmosphere and are received by a low Earth orbit or LEO satellite. GPS-RO is a low cost alternative to conventional sounding measurements which are usually taken by weather balloons.

So far GPS-RO is the only globally available measurement of atmospheric profile in three-dimensions. Conventionally, a few hours of GPS-RO data is assimilated to initialize a forecast run of a global weather model.

However, improved weather forecasting techniques that incorporate more long-term data and have enhanced forecast accuracy would be desirable.

### SUMMARY OF THE INVENTION

The present invention provides techniques for improving weather forecasting using model blending and historical global positioning system-radio occultation (GPS-RO) measurements. In one aspect of the invention, a method for weather forecasting is provided. The method includes: obtaining historical GPS-RO measurements; determining a refractive index of the atmosphere from the GPS-RO measurements; obtaining historical forecasts from multiple individual numerical weather models from a same given time period as the GPS-RO measurements; statistically correcting the historical forecasts using the refractive index of the atmosphere determined from the GPS-RO measurements; blending the numerical weather models using the statistically corrected historical forecasts to create a blended weather model, wherein the blending is performed to improve a forecast of the refractive index of the atmosphere by the blended weather model; and forecasting primary weather parameters using the blended weather model. Secondary weather parameters (e.g., wind speed and/or precipitation) can then be forecasted using the primary weather parameters by physical or statistical methods.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating the principle of Global positioning system-radio occultation (GPS-RO) according to an embodiment of the present invention;

FIG. 2 is a diagram comparing modeling blending and numerical weather prediction (NWP) usage of GPS-RO data according to an embodiment of the present invention;

FIG. 3 is a diagram illustrating an exemplary methodology for weather forecasting according to an embodiment of the present invention;

FIG. 4 is a diagram illustrating an exemplary methodology for blended forecasting of the primary weather parameters using the numerical weather models and historical GPS-RO measurements as training data according to an embodiment of the present invention;

FIG. 5 is a diagram illustrating some examples of individual numerical weather models that can be used for long term forecasting according to an embodiment of the present invention;

FIG. 6 is a diagram illustrating an exemplary methodology for situation categorization and model blending according to an embodiment of the present invention;

FIG. 7 is a diagram illustrating an exemplary methodology for situation categorization and model blending according to an embodiment of the present invention;

FIG. 8 is a diagram illustrating an exemplary methodology for using the optimized forecast of primary weather parameters to forecast optimized secondary weather parameters using physical modeling according to an embodiment of the present invention;

FIG. 9 is a diagram illustrating an exemplary methodology for using the optimized forecast of primary weather parameters to forecast optimized secondary weather parameters using statistical modeling according to an embodiment of the present invention; and

FIG. 10 is a diagram illustrating an exemplary apparatus for performing one or more of the methodologies presented herein according to an embodiment of the present invention.

### DETAILED DESCRIPTION OF PREFERRED EMBODIMENTS

Provided herein are techniques to ingest long periods (months to years) of historical GPS-RO data in order to statistically improve global weather forecasting using self-learning weather modeling technology (SMT). Moreover, techniques are provided herein to downscale such improved global weather forecasts in local regions to enhance spatial resolution using physical and statistical modeling.

The present techniques employ situation-dependent model blending for deriving a weather model. The basic idea is that numerous weather agencies are running many different numerical weather prediction (NWP) models. Knowing a long period of historical forecasts of these NWPs as well as the corresponding historical measurements, machine learning techniques can be applied to find out what NWP(s) is/are most accurate when, where and under what weather conditions. And furthermore, insight can be gained into how to combine the forecasts from different NWP models to make a forecast whose accuracy is superior to all of the models individually.

Here the weather forecasting refers to the forecasting of future atmospheric states from short term (hours to 3 days ahead), medium term (3 to 10 days ahead), to long term (10 days to months ahead). See, for example, U.S. patent application Ser. No. 14/797,777, entitled “Parameter-Dependent Model-Blending with Multi-Expert Based Machine Learning and Proxy Sites,” designated as Attorney Docket Number YOR920150524US1 (hereinafter “U.S. patent application Ser. No. 14/797,777”), the contents of which are incorporated by reference as if fully set forth herein. So far the application of the situation-dependent model blending to weather forecasting is typically limited to the forecasting of land surface parameters where measurement of temperature, humidity, wind speed, and solar irradiance is available.

In comparison, the measurement of atmosphere as a function of vertical height or over oceans (or other bodies of water) is much rarer, as there are no weather stations in those locations. Historically, measurements as a function of vertical height are taken using aircraft or weather balloons which are relatively expensive to implement. Advantageously, the present techniques provide model blending techniques that can be used for optimizing atmospheric forecasting in three-dimensions (3D) (i.e., both lateral and vertical) or over oceans (or other locals) where there are no weather station measurements available. The model blending is trained using GPS-RO measurement dataset.

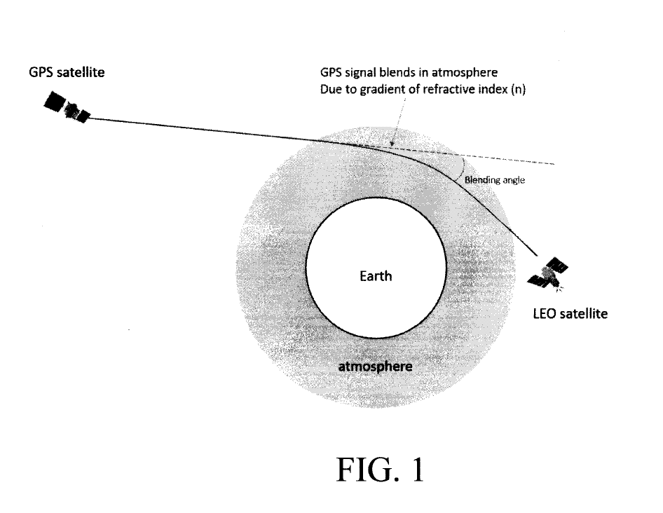

As provided above, GPS-RO is a technique for profiling the state of the atmosphere as a function of vertical height. It is a low cost alternative to conventional sounding measurement usually taken by aircraft, weather balloons, etc. The principle of GPS-RO is illustrated in FIG. 1.

As shown in FIG. 1, GPS satellites in high orbital send microwave (wavelengths around 19 centimeters (cm) and 24 cm) GPS signal (see signal lines in FIG. 1), the signal passes through the atmosphere and is received by a LEO satellite. Note that the refractive index (n) of the atmosphere for the microwave is determined by the temperature (T), pressure (P), and relative humidity (RH) of the atmosphere. Generally, with increasing altitude, the air density (determined by temperature and pressure) decreases as does the moisture content (determined by temperature and relative humidity), and thus the refractive index (n) becomes smaller.

As shown in FIG. 1, the GPS signal bends in the atmosphere due to the vertical gradient of the refractive index (n) of the atmosphere. By measuring the phase of the GPS signals, one can determine the bending angle of the GPS-RO signal. From the bending angle of the GPS-RO signal one can determine the current refractive index (n) of the atmosphere. Knowing the current refractive index (n) of the atmosphere, which is a function of temperature (T), pressure (P), and relative humidity (RH), one of the three variables (T, P, RH) can be computed if the other two are known (e.g. from a global weather forecasting model). Alternatively, the current GPS-RO measurement can be combined with a given atmospheric state (determined by an NWP model) using a one-dimensional variational method (1D-Var) to accurately obtain the current atmospheric state (more accurately than using the NWP model alone). Today GPS-RO provides a far larger volume of 3D atmospheric measurements than previously possible using weather balloon or aircraft.

Conventionally, GPS-RO measurements are used in the aforementioned way to provide a more accurate initial atmospheric state for NWP modeling. NWP modeling is basically a set of coupled differential equations that simulate the motion of the atmosphere. If one has a better knowledge of the initial condition (provided by GPS-RO), one can simulate and forecast the future state of the atmosphere more accurately. This is how GPS-RO is used for weather modeling conventionally. Such NWP application of GPS-RO is discussed, for example, in Cucurull et al., “Assimilation of Global Positioning System Radio Occultation Observations into NCEP's Global Data Assimilation System,” Monthly Weather Review, vol. 135, 3174-3193 (September 2007), the contents of which are incorporated by reference as if fully set forth herein.

The present techniques provide a different method for using GPS-RO to improve weather forecasting (particularly long term weather forecasting). Namely, instead of using GPS-RO to provide the current state of the atmosphere in order to initialize a numerical weather model, a long period of historical GPS-RO data is used to train the blending of multiple NWP models to achieve optimal forecasting accuracy. For the purpose of model blending, advantageously, as provided above, GPS-RO provides high density measurements over oceans (or other locals) where there is no weather station data available.

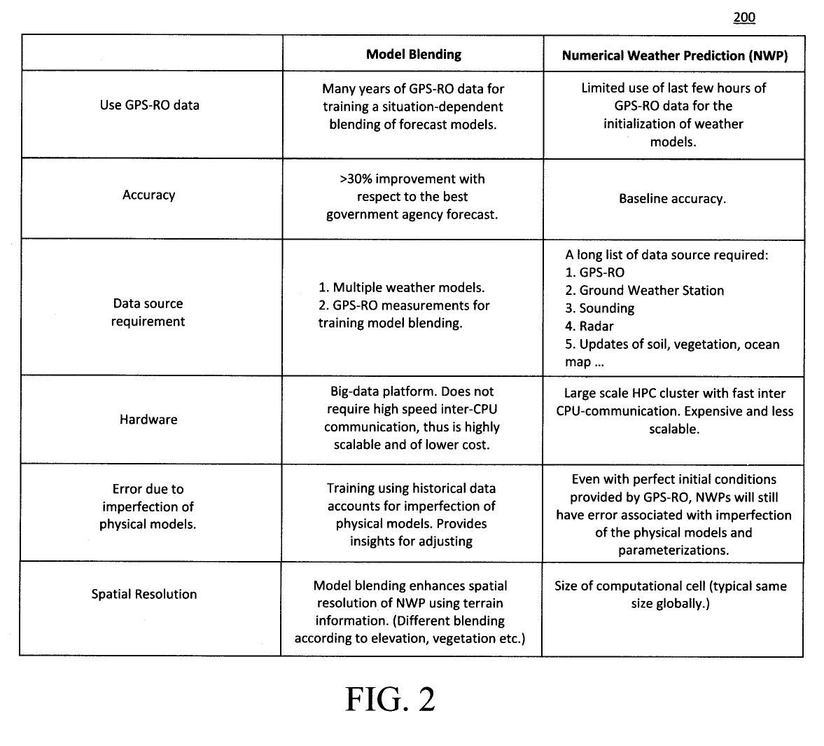

A comparison of the present model blending techniques (labeled “Model Blending”) and conventional NWP (labeled “Numerical Weather Prediction (NWP)”) usage of GPS-RO data is shown in table 200 of FIG. 2. As shown in table 200, only a limited amount of GPS-RO data is used in NWP to initialize the weather models. This is done to improve the (baseline) accuracy of the initial conditions of the numerical weather models, with the goal being to improve the overall forecasting accuracy of such models.

By comparison, many years of historical GPS-RO data are leveraged in the present model-blending techniques. These historical GPS-RO measurements are used to statistically correct the results of a set of global numerical weather models. The accuracy of the corrected results surpasses that of the best numerical weather models in the set. As shown in table 200, the present model blending method takes as its data sources 1) a set of (multiple) numerical weather forecast/prediction models and 2) GPS-RO measurements. The GPS-RO measurements are used to train the model blending process to achieve a corrected model that is more accurate than even the best numerical weather model in the set.

There are some unique challenges to using GPS-RO data for weather forecasting as compared to, e.g., weather station measurements. First (challenge 1), using model blending to forecast a parameter requires historical measurement of the same parameter. GPS-RO measurements do not directly give temperature, pressure, and humidity (the three primary parameters). As provided above, GPS-RO measurements only provide the refractive index (n) which is a function of these three primary parameters. Thus even for forecasting these three parameters, the problem is underdetermined to an extent. Second (challenge 2), the forecasting requirement often goes beyond these three primary parameters. For instance, parameters of interest also include precipitation, wind speed, etc. GPS-RO measurements do not contain information for such parameters.

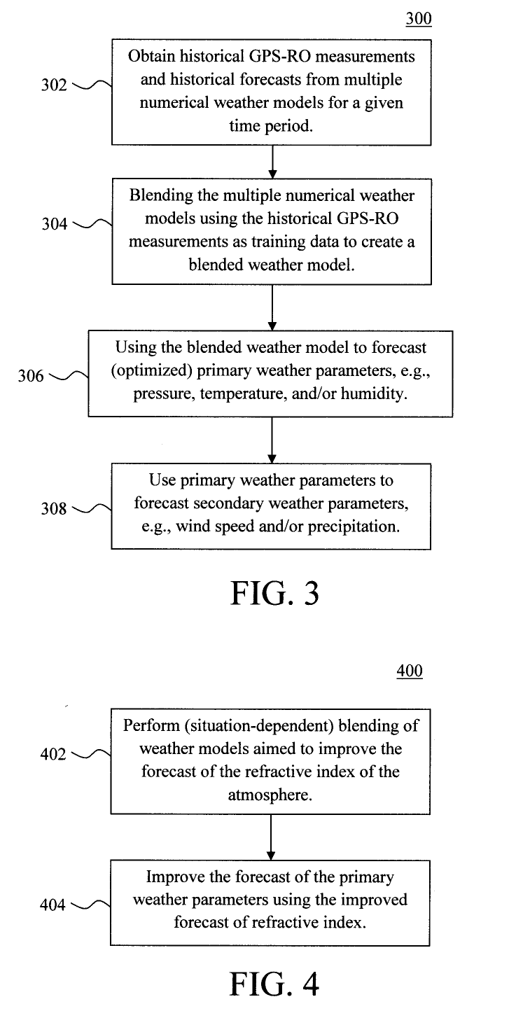

In accordance with the present techniques, FIG. 3 is a diagram illustrating an exemplary methodology 300 for weather forecasting. In step 302, historical GPS-RO and historical forecasts from multiple individual numerical weather models are obtained for a given time period (in the past). The length of the historical measurements typically is in the range of one month to multiple years. The maximum length of historical measurements usable for model blending is limited by the factor that the configuration of the weather models has to remain essentially the same during the time period. If one of the weather models had a major upgrade, then the historical data before the time of the upgrade is no longer usable. Each individual numerical weather model forecasts what are referred to herein as primary weather parameters such as pressure, temperature and/or relative humidity for the given time period. As will be described in detail below (see, e.g., Equation 1, below), these primary weather parameters can be used to determine the refractive index (n) of the atmosphere. Advantageously, the (historical) GPS-RO measurements from the same given time period provide an actual measurement (of refractive index (n)) against which the forecasts (predictions) can be compared and statistically corrected. Namely, in step 304, multiple numerical weather models are blended using the historical GPS-RO measurements as training data (against which the historical forecasts from the models can be compared—see above) to create a blended weather model. By using the historical GPS-RO training data, the blended weather model is now optimized for making future forecasts of the primary weather parameters (e.g., pressure, temperature, and/or relative humidity).

Namely, in step 306 the blended weather model is then used to forecast primary weather parameters, such as pressure, temperature, and/or relative humidity. The primary weather parameters are used in step 308 to forecast what are referred to herein as secondary weather parameters. Secondary weather parameters include, for example, wind speed and/or precipitation, and can be derived from the primary weather parameters using statistical and/or physical methods (see below).

Methodology 300 effectively addresses the above-described challenges associated with using GPS-RO measurements. For instance, regarding the challenge 1 that GPS-RO provides only refractive index (n) data, the present model blending process aims to improve the forecast of refractive index based on the historical GPS-RO data which, as provided above, is a function of the primary weather parameters. Regarding the challenge 2 that there are other parameters of interest (i.e., secondary weather parameters), the present process provides both statistical and physical methods for deriving these values from the primary weather parameters derived from the blended model.

A detailed description of the blended forecasting of the primary weather parameters using the numerical weather models and historical GPS-RO measurements as training data (i.e., steps 302 and 304 of methodology 300) is now provided by way of reference to methodology 400 of FIG. 4. The challenge (challenge 1) that GPS-RO does not provide direct measurement of temperature (T), pressure (P), and relative humidity (RH) is solved, in step 402, by performing (situation-dependent) blending of the weather models aimed to improve the forecast of the refractive index of the atmosphere and, in step 404, improving the forecast of the primary weather parameters (i.e., temperature, pressure, and/or relative humidity) by a primary weather model using the improved forecast of refractive index (n). By way of example only, the historically most accurate weather model among the multiple input weather models can be selected as the primary weather model. Alternatively, the equally weighted mean of the multiple input weather models may be used as the primary weather model.

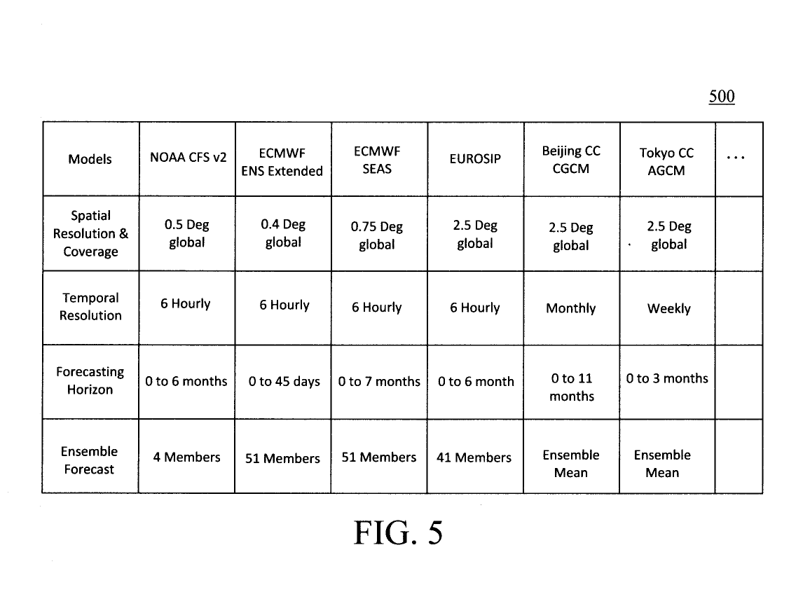

Regarding step 402, FIG. 5 is a table 500 that provides examples of suitable long term (e.g., over 10 days) numerical weather models that may be used as input for the present process. By way of example only, the numerical weather models shown in FIG. 5 include: the national oceanic and atmospheric administration climate forecast system (NOAA CFS) model, European center for medium range weather forecasting—ensemble prediction system (ECMWF ENS extended forecast) and (ECMWF SEAS—Seasonal 7-month forecast) models, the European seasonal-to-inter-annual prediction (EUROSIP) model, a coupled general circulation model (CGCM), and an atmospheric general circulation model (AGCM). A different set of weather models will be involved in short term (0-3 days) and medium term (3-10 days) forecasting. Weather models applicable for short term forecasting include, but are not limited to, the Rapid Refresh model (RAP), High-resolution Rapid Refresh model, North American Mesoscale model (NAM), and Short Range Ensemble Forecast Model (SREF) from National Oceanic and Atmospheric Administration (NOAA). Weather models applicable for medium term forecasting include, but are not limited to, the Global Forecast System (GFS) from NOAA, Integrated Forecast System (IF) from the European Center for Medium Range Weather Forecasts (ECMWF), and the Global Environmental Multiscale Model (GEM) from the Canadian Meteorological Center (CMC).

From the individual numerical weather models, the refractive index (n) of the atmosphere (at the microwave wavelength of the GPS signal) can be computed as:

$$n ( z ) = 0.776 ( \frac{P ( z )}{T ( z )} ) + 3.73 \times {10}^{3} ( \frac{{P}_{WS} ( T ( z ) ) \cdot RH ( z )}{{T ( z )}^{2}} ) , \qquad ( 1 )$$

wherein n(z) is the refractive index as a function of vertical height z, P(z) is the total atmospheric pressure in hectopascals (hPa), RH(z) is the relative humidity, P_{WS}(T(z)) is the saturating (100% humidity) water vapor pressure in hPa at temperature T in Kelvin, which may be approximated by the Clausius-Clapeyron relation for water vapor,

$${P}_{WS} = 6.1079 \times {10}^{\frac{7.5 * ( T - 273.15 )}{T - 35.85}} , \qquad ( 2 )$$

wherein P_{WS} is in hPa and T is in Kelvin.

The individual numerical weather models forecast future weather conditions. Thus, what one has at this stage is a forecast of the refractive index (n) of the atmosphere based on the numerical weather models. As provided above, the bending angle of the GPS-RO signal can be used to determine the refractive index (n) of the atmosphere. Therefore, by having historical GPS-RO measurements (i.e., previously measured values), one can statistically correct the refractive index (n) forecast from the weather models using a trained model blending process. Namely, using the historical measurement of refractive index n(z) by GPS-RO and forecasts of n(z) from individual weather models one can train a blended model yielding a more accurate forecast of n(z) using situation dependent model blending. The historical GPS-RO data is available, for example, from the constellation of COSMIC (Constellation Observing System for Meteorology, Ionosphere, and Climate) satellites. As described above, the maximum length of historical GPS-RO measurements usable for model blending is limited by time period in which the configuration of the weather models remains stable. For a description of suitable model blending techniques see, for example, U.S. patent application Ser. No. 14/797,777.

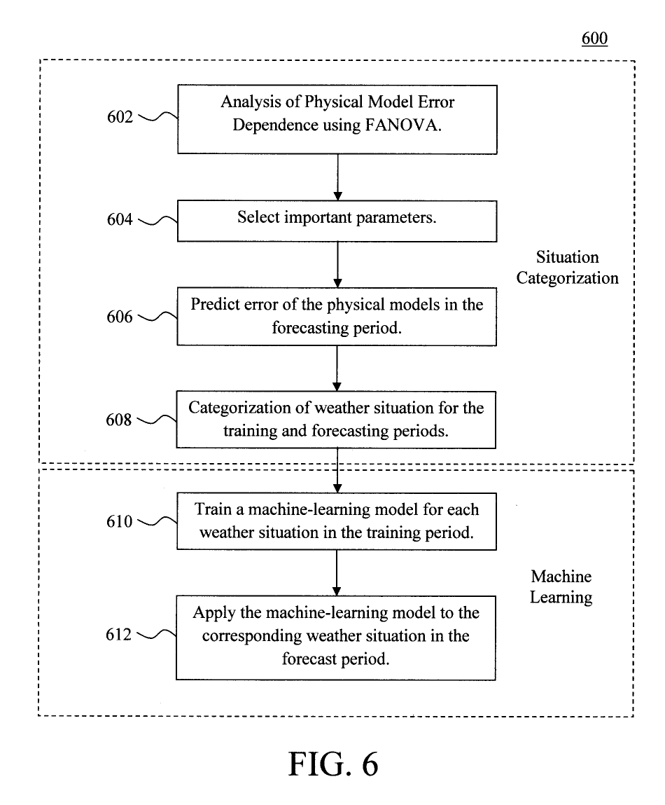

By way of example only, FIG. 6 provides an exemplary methodology 600 for situation categorization and model blending. As shown in FIG. 6, the process includes two main phases: 1) situation characterization where weather situations are categorized for the forecasting period, and 2) machine learning where a trained machine learning model is applied to the weather situations for the forecasting period. More specifically, categorization of the weather situations begins in step 602 by analyzing how the systematic errors of the predicted parameter of interest (here refractive index (n)) by the individual forecast models is dependent on a set of meteorological state parameters (such as temperature, pressure, humidity, solar irradiance, solar zenith angle, wind speed and direction, elevation etc.) using functional analysis of variance (FANOVA). As is known in the art, FANOVA is a technique for using statistical models to analyze variance and explain observations. FANOVA quantifies how the error of the parameter of interest (here predicted refractive index) is correlated with the value of individual state parameters (1^{st} order), or with the value of a pair of parameters (2^{nd} order) while the impact of the other state parameters are averaged out. See, for example, U.S. patent application Ser. No. 14/797,777, and S. Lu, et al, “Machine Learning Based Multi-Physical-Model Blending for Enhancing Renewable Energy Forecast—Improvement via Situation Dependent Error Correction,” Proceeding of European Control Conference 2015, pp. 283-290 (July 2015), the contents of which are incorporated by reference as if fully set forth herein. From the FANOVA results, the set of important parameters are selected from all available atmospheric state parameters in step 604. The important parameters are those parameters which, according to FANOVA results, have the highest correlation with the error of the predicted parameter of interest.

For instance, when multiple input physical models are involved, the dimensionality of the space formed by the important parameters from the multiple models increases. According to an exemplary embodiment, since the ultimate goal is to combine the different weather models so that their error can be reduced, an intuitive way for situation categorization is to categorize them according to the expected errors of the individual models which are in turn linked to the important parameters via the FANOVA derived error dependences. An unsupervised classification learning algorithm (for example Gaussian mixture models) can be used to classify situation categories. For a given forecasting data point, one first computes the expectation of the error of the individual models using FANOVA by summing up the error dependences on all important parameters (step 606) and then uses the trained unsupervised classification learning model (e.g. Gaussian mixture model) to categorize the data points (step 608).

For each situation category within given periods of training data and forecast data, a supervised machine learning model is independently trained on the training time period (step 610) and applied to the forecast time period (step 612). A supervised machine learning model basically establishes a statistical correlation between the response variables and the predictor variables. Common algorithms used to train a machine learning model include neural net (NN), random forest (RF), support vector machine (SVM), generalized linear model (GLM), gradient boosting model (GBM), etc. Here the response variables are the measurements of the quantity of interest (refractive index (n)) by the GPS-RO technique. In the simplest form, predictor variables are the predictions of the quantity of interest (refractive index (n)) by different NWPs and predictions of selected important parameters. Using a simple non-limiting example to illustrate this concept: if the data is contained in a table then the first column of the table contains the response variables, in this case the historically measured refractive index (n). The other columns of the table contain are the predictor variables, which include the refractive index predicted from weather models 1, 2, 3, 4, etc., as well as other important variables (such as temperature, pressure, wind speed, solar irradiance, etc.) predicted by these weather models 1, 2, 3, 4, etc. The machine learning algorithm finds the correlation between the first column versus all of the other columns. For time points in the future, historical measurements from the first column obviously are not available. Thus, one uses the other columns and the correlation (machine learning model) to guess the first column.

Referring back to step 404 of methodology 400 (of FIG. 4), the forecast of the primary weather parameters (i.e., temperature, pressure, and/or relative humidity) can now be improved using the improved forecast of the refractive index (n). Note that the temperature, pressure, and relative humidity forecasts are associated with a finite error and thus a probabilistic distribution. For example, if the error of the temperature forecast is assumed to follow a Gaussian distribution and the forecast provides an expected value of temperature T₀, and has an error (represented by variance) of σ_{T}², then the probability density of the temperature being T is

$$f ( T ) = \frac{1}{\sqrt{2 {σ}_{T}^{2} π}} {e}^{- \frac{{( T - {T}_{0} )}^{2}}{2 {σ}_{T}^{2}}} .$$

Similarly, pressure and relative humidity also have an error distribution f(P), f(RH). The task is to find out, given the refractive index of the atmosphere using model blending as just described, what is the most probable combination of temperature, pressure, and/or relative humidity which satisfies the blended refractive index (n) (Equation 1 above). The term “most probable” here means the temperature (T), pressure (P), relative humidity (RH) and refractive index (n) (i.e., which is determined by T, P, RH) having the largest joint probability density. In one exemplary embodiment, error distributions of T, P, RH, and n are all assumed to be Gaussian, and the joint probability is

$$f ( T ) f ( P ) f ( RH ) f ( n ) = \frac{1}{4 {π}^{2} \sqrt{{σ}_{T}^{2} {σ}_{P}^{2} {σ}_{RH}^{2} {σ}_{n}^{2}}} {e}^{- [ \frac{1}{2} {{σ}_{T}^{2} ( T - {T}_{0} )}^{2} + \frac{1}{2} {{σ}_{T}^{2} ( P - {P}_{0} )}^{2} + \frac{1}{2} {{σ}_{T}^{2} ( RH - {RH}_{0} )}^{2} + \frac{1}{2} {{σ}_{n}^{2} ( n - {n}_{0} )}^{2} ]} \qquad ( 3 )$$

wherein T₀, P₀, RH₀, n₀ are the expectation values of Gaussian distribution of T, P, RH and n and σ_{T}², σ_{P}², σ_{RH}², σₙ² are their variance. It is trivial to show that maximizing the probability of Equation 3 is equivalent of minimizing a cost function (which is the exponent in Equation 3) of:

$$Cost = \frac{1}{2} {{σ}_{T}^{2} ( T - {T}_{0} )}^{2} + \frac{1}{2} {{σ}_{T}^{2} ( P - {P}_{0} )}^{2} + \frac{1}{2} {{σ}_{T}^{2} ( RH - {RH}_{0} )}^{2} + \frac{1}{2} {{σ}_{n}^{2} ( n - {n}_{0} )}^{2} \qquad ( 4 )$$

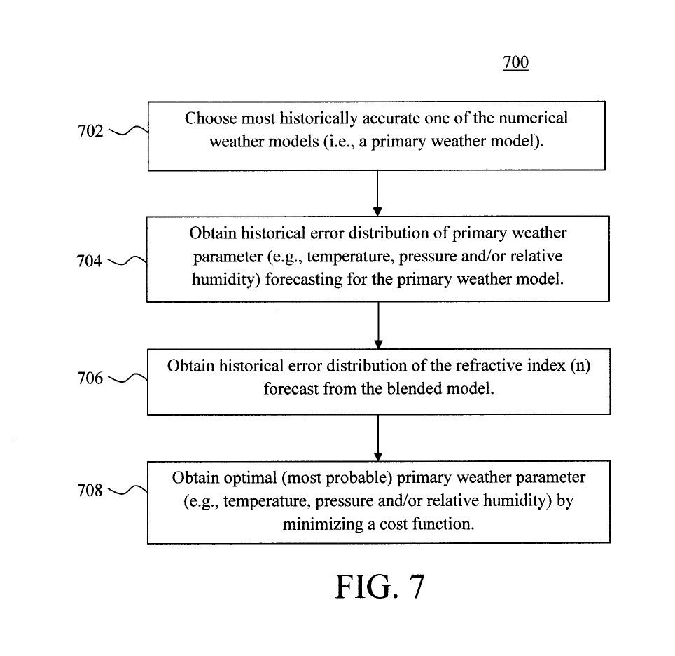

In reality, the mathematical formulation for obtaining optimized T, P, RH needs to be extended because T, P, RH, and n of the atmosphere are height (z) dependent, thus are represented by vectors. According to an exemplary embodiment shown illustrated as methodology 700 in FIG. 7, a variational method is employed, wherein one first chooses a weather forecasting model which is also historically the most accurate model among the numerical weather models available. See step 702. As provided above, the historical GPS-RO measurements from the same given period can be compared against the historical model predictions from the same period to determine the accuracy of the individual models. This (most historically accurate) weather forecasting model is also referred to herein as the “primary forecasting model” or simply as the “primary model.” Suppose, for example, that the primary model forecasted expectation values of Temperature T₀(z), Relative Humidity RH₀(z), and Pressure P₀(z)(note that temperature, pressure, and relative humidity are a function of vertical height z). A vector \vec{T}₀, \vec{RH}₀, \vec{P}₀, is used to represent the discrete T₀(z), RH₀(z), and P₀(z) respectively, at the discrete z levels.

The historical forecasting error distribution of the primary model for Temperature \vec{T}₀, Relative Humidity \vec{RH}₀, Pressure \vec{P}₀ is first determined in step 704. The forecasting error can be determined, for example, by comparing forecasting with actual measurements taken, e.g., using weather balloons and/or aircraft. Here the symbols Σ_{T}, Σ_{P}, Σ_{RH} are used to represent the covariance matrix of the error of vector \vec{T}₀, \vec{P}₀, \vec{RH}₀.

It is notable that the covariance matrix of a vector is a matrix whose element in the i, j position is the covariance between the i^{th} and j^{th} elements of the vector. Covariance measures how much two variables (X, Y) change together and is defined below. In this context, the two variables are the error of temperature (or pressure, relative humidity) at two levels. Covariance are defined as:

Covariance(X,Y)=E[(X−E(X))(Y−E(Y))],

wherein E(X) represent the expectation value of variable X.

In step 706, the historical forecasting error distribution of the blended forecast of the refractive index (n) is determined using historical GPS-RO measurements during the same time period as step 704. Note that two periods of historical data are involved. The first historical period is used to train a blended model (step 602-step 610). The blended model is then applied to a second historical period to obtain a blended forecast of reflective index (n) which is compared to measurements to derive the error distribution. Symbol Σₙ is used as the covariance matrix of the error of \vec{n}_{blend} (wherein the vector \vec{n}_{blend} represents the blended refractive index at discrete z levels).

Following multi-variate Gaussian distribution the error of vector \vec{T}, \vec{P}, \vec{RH}, \vec{n} is assumed. The probability density of having temperature vector \vec{T} is:

$$f ( \vec{T} ) = \frac{1}{\sqrt{{( 2 π )}^{k} \vert {E}_{T} \vert}} exp ( \frac{1}{2} {( \vec{T} - {\vec{T}}_{0} )}^{T} \underline{{\sum }_{T}^{- 1}} ( \vec{T} - {\vec{T}}_{0} ) ) . \qquad ( 5 )$$

The probability densities of f(\vec{P}), f(\vec{RH}), and f(\vec{n}) can be expressed similar to Equation 5. Thus the optimal \vec{T}, \vec{P}, \vec{RH}(again the vector representing temperature, pressure and relative humidity at discrete z levels) can then be determined in step 708 by maximizing joint probability density f(\vec{T})f(\vec{P})f(\vec{RH})f(\vec{n}) or equivalently minimizing a cost function:

$$Cost = \frac{1}{2} {( \vec{T} - {\vec{T}}_{0} )}^{T} \underline{{\sum }_{T}^{- 1}} ( \vec{T} - {\vec{T}}_{0} ) + \frac{1}{2} {( \vec{P} - {\vec{P}}_{0} )}^{T} \underline{{\sum }_{P}^{- 1}} ( \vec{P} - {\vec{P}}_{0} ) + \frac{1}{2} {( \vec{RH} - {\vec{RH}}_{0} )}^{T} {\sum }_{RH}^{- 1} ( \vec{RH} - {\vec{RH}}_{0} ) + \frac{1}{2} {( \vec{n} - {\vec{n}}_{blend} )}^{T} \underline{{\sum }_{n}^{- 1}} ( \vec{n} - {\vec{n}}_{blend} ) , \qquad ( 6 )$$

wherein vector \vec{n} represents the refractive index corresponding to the optimal (most probable) \vec{T}, \vec{P}, \vec{RH}(using Equation 1, above). The terms are summed up because they are exponents in the Gaussian probabilities (i.e., when multiplying the probabilities, the exponents sum up). Note that Equation 5 is an extension of Equation 4 as temperature is now a vector. The first term ½(\vec{T}−\vec{T}₀)^{T}Σ_{T}⁻¹(\vec{T}−\vec{T}₀), for example is the exponent of in probability density of temperature f(\vec{T}).

The cost needs to be minimized with the constraint of the following relationship between temperature, pressure, and relative humidity,

$$\frac{dP ( z )}{dz} = - ρ ( T ( z ) , P ( z ) , RH ( z ) ) g , \qquad ( 7 )$$

wherein ρ(T(z),P(z),RH(z)) is the air density which is a function of temperature, pressure, and relative humidity. Symbol g represents the gravity of the Earth ˜9.8 m/s².

The cost function of Equation 3 can be minimized using, for example, a gradient descent method. The minimization of the cost function produces the optimal (most probable) temperature, pressure, and relative humidity which conforms to the refractive index (n) from the blended forecast by satisfying Equation 1 and 2, above. Thus the optimal temperature, pressure, and relative humidity are expected to be more accurate than the forecasts of the primary weather model.

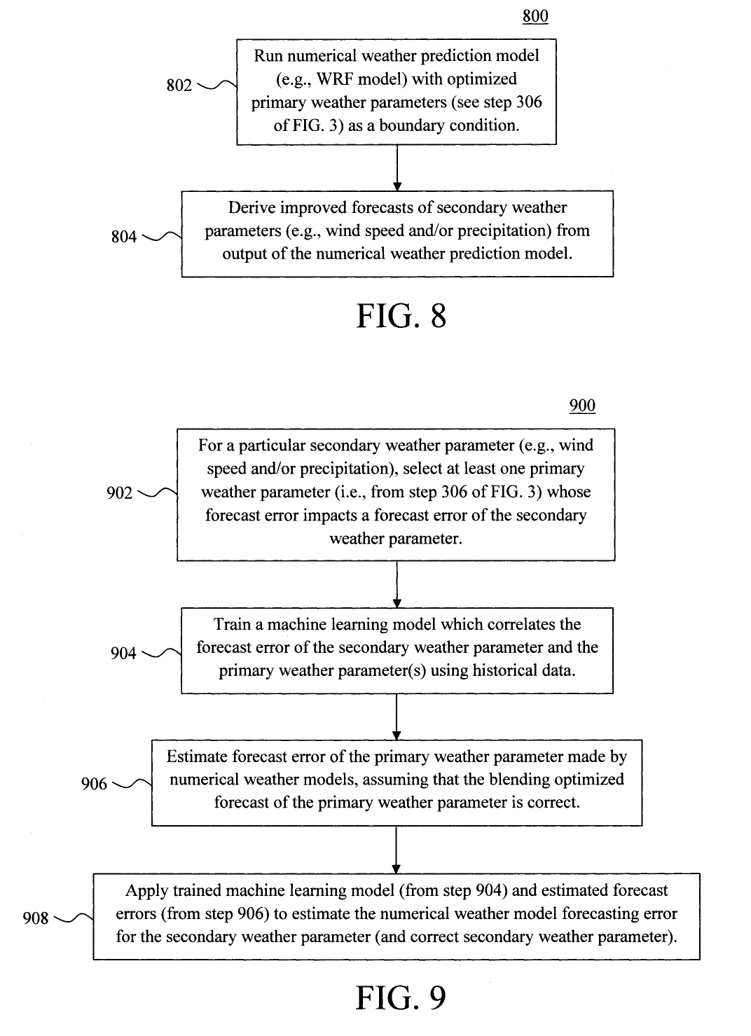

A detailed description of converting from forecasts of primary weather parameters (e.g., temperature, pressure, and relative humidity) to secondary weather parameters (e.g., wind speed, precipitation, etc.) (i.e., step 306 of methodology 300) is now provided by way of reference to FIGS. 8 and 9. As noted above, there are two approaches for deriving the secondary weather parameters from the primary weather parameters, namely (1) a physical approach (i.e., methodology 800 of FIG. 8) and (2) a statistical approach (i.e., methodology 900 of FIG. 9).

Referring to methodology 800 of FIG. 8, with a physical approach numerical weather prediction models are used, such as the weather research forecast (WRF) model, which is an open source weather model. See, for example, Done et al., “The next generation of NWP: explicit forecasts of convection using the weather research and forecasting (WRF) model,” Atmospheric Science Letters, 5: pgs. 110-117 (September 2004), the contents of which are incorporated by reference as if fully set forth herein. In step 802, the weather model takes the temperature (T), pressure (P), and relative humidity (RH) (i.e., from step 306 of FIG. 3) in the future forecasted by the model blending approach as the boundary conditions. These optimized primary weather parameters have an improved accuracy as compared to what is otherwise available from the starting numerical weather models individually. It is notable that temperature (T), pressure (P), and relative humidity (RH) forecast from steps 302 and 304 are a function of (x,y,z,t), where x, y, z forms a 3D spatial grid. Time t is a set of discrete time point in the future.

In step 804, the weather model solves a set of differential equations using the (optimized) boundary conditions to predict the motion of the atmosphere and all the parameters of the atmospheric state which include the secondary parameters of interest (such as wind speed and precipitation). A common open source model is the WRF model. Because the model blending of the present techniques produces a more accurate forecasting of the primary parameters, the resultant forecasts of secondary parameters will be more accurate as well.

Referring now to methodology 900 of FIG. 9, the statistical approach relies on known correlations between the primary parameters (i.e., from step 306 of FIG. 3) and the secondary parameters. One example is that in mid-latitude regions, the wind speed is related to mean sea level pressure gradient. The higher the pressure gradient, the higher the wind speed. Then if a weather model under-predicts (or over-predicts) the pressure gradient at a location, it is likely to under-predict (or over-predict) the wind speed. Accordingly, in step 902, for a particular secondary weather parameter (e.g., wind speed and/or precipitation), at least one primary weather parameter (i.e., from step 306 of FIG. 3) is selected whose error impacts an error of the secondary weather parameter.

In one embodiment one may select a weather model which historically is the most accurate in predicting the secondary weather parameter among the multiple available weather models (see examples given above) and use this weather model as the primary weather model. In step 904, a machine learning model can be trained using historical data which correlates the primary model's forecast error of the secondary weather parameter and the error of the primary weather parameter(s). The historical data, i.e., the error of the secondary and primary weather parameters, can be obtained by comparing the model's prediction with measurements taken for instance by weather station or weather balloon. The maximum time period for the historical data is limited by the time period in which the primary model's configuration remains unchanged. If a weather agency made a major upgrade of a primary weather model, historical data before the upgrade would no longer be usable. In step 906, forecast error of the primary weather parameter made by the primary weather model can be estimated, assuming that the blending optimized forecast of the primary weather parameter is correct. In step 908, the trained machine learning model (from step 904) and the estimated forecast errors (from step 906) can be applied to estimate the numerical weather model forecasting error for the secondary weather parameter (and correct the secondary weather parameter).

As an example, using historical data one can train a supervised machine learning model of:

v˜vₘ,(∇P−∇Pₘ),x,s, (8)

wherein the response variable (the actual wind speed at, e.g., 10 meters above the Earth's surface) is v, the predictor variable is vₘ the wind speed, e.g., at 10 meters above the Earth's surface predicted by the primary weather model, ∇P−∇Pₘ is the difference between the actual pressure gradient (∇P) and the pressure gradient predicted by the primary weather model (∇Pₘ) at sea level, x is the location, and s is the weather situation. It is notable that the machine learning model essentially reflects how to correct the primary weather model's forecast of the wind speed depending on the forecast's pressure gradient error ∇P−∇Pₘ, the location x, and the weather situation s. For future forecasts, the pressure gradient estimate from pressure forecasted by step 708 is a more accurate forecast than from the pressure forecasted by the primary weather model. Thus, the blended pressure gradient is used in place of ∇P in Equation 8 and the training machine learning model is used to estimate the actual wind speed.

As another example, the precipitation at the Earth's surface is correlated with 500 hPa height (the height at which the atmospheric pressure is 500 hPa) and humidity. The lower the 500 hPa height and higher the humidity, the larger the precipitation is likely to be. Then if a weather model under-predicts (or over-predicts) the 500 hPa height or over-predicts (or under-predicts) the humidity (averaged over the entire column of atmosphere) it is likely to over-predict (or under-predict) the precipitation. Thus using historical data one can train a supervised machine learning model of:

p˜pₘ,(z^{500 hpa}−zₘ^{500 hPa}),(RH−RHₘ),x,s, (9)

wherein the response variable is the actual precipitation p, the predictor variable is the precipitation predicted by the primary weather model pₘ, z^{500 hPa}−zₘ^{500 hPa} is the difference between the actual 500 hPa height (z^{500 hPa}) and the 500 hPa height predicted by the primary weather model (zₘ^{500 hPa}), RH−RHₘ is the difference between the actual humidity (RH) and the humidity predicted by the primary weather model RHₘ, x is the location, and s is the weather situation. Once trained, for future forecasting the 500 hPa height and humidity from the blended model can be applied in place of z^{500 hPa} and RH in Equation 9, above, to estimate the actual precipitation. Beyond wind speed and precipitation, other atmospheric parameters can also be correlated with the three primary parameters (pressure, temperature, and humidity) using similar statistical methods.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

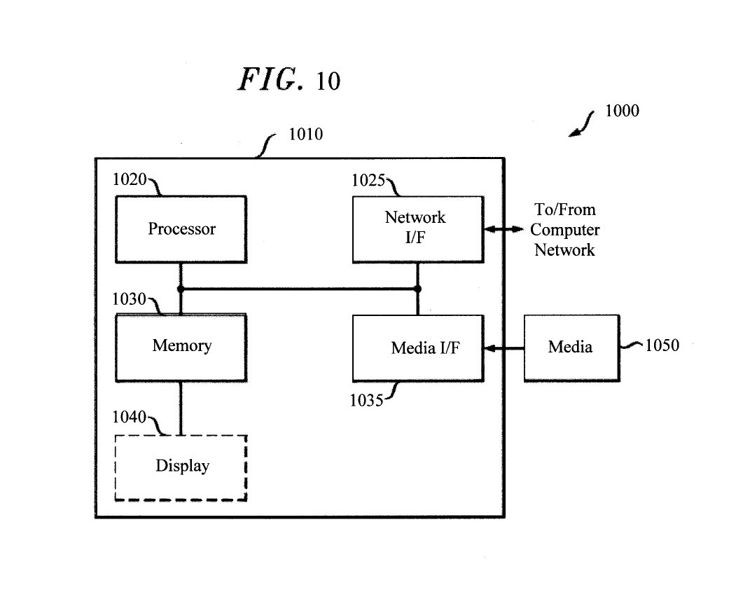

Turning now to FIG. 10, a block diagram is shown of an apparatus 1000 for implementing one or more of the methodologies presented herein. Apparatus 1000 includes a computer system 1010 and removable media 1050. Computer system 1010 includes a processor device 1020, a network interface 1025, a memory 1030, a media interface 1035 and an optional display 1040. Network interface 1025 allows computer system 1010 to connect to a network, while media interface 1035 allows computer system 1010 to interact with media, such as a hard drive or removable media 1050.

Processor device 1020 can be configured to implement the methods, steps, and functions disclosed herein. The memory 1030 could be distributed or local and the processor device 1020 could be distributed or singular. The memory 1030 could be implemented as an electrical, magnetic or optical memory, or any combination of these or other types of storage devices. Moreover, the term “memory” should be construed broadly enough to encompass any information able to be read from, or written to, an address in the addressable space accessed by processor device 1020. With this definition, information on a network, accessible through network interface 1025, is still within memory 1030 because the processor device 1020 can retrieve the information from the network. It should be noted that each distributed processor that makes up processor device 1020 generally contains its own addressable memory space. It should also be noted that some or all of computer system 1010 can be incorporated into an application-specific or general-use integrated circuit.

Optional display 1040 is any type of display suitable for interacting with a human user of apparatus 1000. Generally, display 1040 is a computer monitor or other similar display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for weather forecasting, comprising:
obtaining historical global positioning system-radio occultation (GPS-RO) measurements;
determining a refractive index of the atmosphere from the GPS-RO measurements;
obtaining historical forecasts from multiple individual numerical weather models from a same given time period as the GPS-RO measurements;
statistically correcting the historical forecasts using the refractive index of the atmosphere determined from the GPS-RO measurements;
blending the numerical weather models using the statistically corrected historical forecasts to create a blended weather model, wherein the blending is performed to improve a forecast of the refractive index of the atmosphere by the blended weather model; and
forecasting primary weather parameters using the blended weather model.

2. The method of claim 1, wherein the primary weather parameters are selected from the group consisting of: pressure, temperature, relative humidity, and combinations thereof.

3. The method of claim 1, further comprising:
forecasting secondary weather parameters using the primary weather parameters.

4. The method of claim 3, wherein the secondary weather parameters are selected from the group consisting of: wind speed, precipitation, and combinations thereof.

5. The method of claim 1, further comprising:
using the improved forecast of the refractive index of the atmosphere to improve a forecast of the primary weather parameters.

6. The method of claim 5, further comprising:
obtaining a historical error distribution for forecasts of the primary weather parameters by a primary one of the numerical weather models;
obtaining a historical error distribution for the forecast of the refractive index of the atmosphere from the blended weather model; and
minimizing a cost function to obtain optimized forecasts for the primary weather parameters that conform to the forecast of the refractive index of the atmosphere.

7. The method of claim 6, further comprising:
determining which one of the numerical weather models is most historically accurate using the GPS-RO measurements; and
using the most historically accurate numerical weather model as the primary numerical weather model.

8. The method of claim 3, further comprising:
running a numerical weather prediction model with the primary weather parameters forecast using the blended weather model as a boundary condition; and
obtaining forecasts of the secondary weather parameters from the numerical weather prediction model.

9. The method of claim 8, wherein the numerical weather prediction model comprises a weather research forecast (WRF) model.

10. The method of claim 3, further comprising:
for a given one of the secondary weather parameters, selecting at least one of the primary weather parameters having a forecast error that impacts a forecast error of the given secondary weather parameter;
training a machine learning model which correlates the forecast error of the given secondary weather parameter and the forecast error of the at least one primary weather parameter using historical data;
estimating the forecast error of the at least one primary weather parameter; and
estimating the forecast error of the given secondary weather parameter using i) the trained machine learning model and ii) the estimated forecast error of the at least one primary weather parameter.

11. A non-transitory computer-readable program product for weather forecasting, the computer-readable program product comprising a computer readable storage medium having program instructions embodied therewith which, when executed, cause a computer to:
obtain historical global positioning system-radio occultation (GPS-RO) measurements;
determine a refractive index of the atmosphere from the GPS-RO measurements;
obtain historical forecasts from multiple individual numerical weather models from a same given time period as the GPS-RO measurements;
statistically correct the historical forecasts using the refractive index of the atmosphere determined from the GPS-RO measurements;
blend the numerical weather models using the statistically corrected historical forecasts to create a blended weather model, wherein the blending is performed to improve a forecast of the refractive index of the atmosphere by the blended weather model; and
forecast primary weather parameters using the blended weather model.

12. The computer-readable program product of claim 11, wherein the primary weather parameters are selected from the group consisting of: pressure, temperature, relative humidity, and combinations thereof.

13. The computer-readable program product of claim 11, wherein the program instructions, when executed, further cause the computer to:
forecast secondary weather parameters using the primary weather parameters.

14. The computer-readable program product of claim 13, wherein the secondary weather parameters are selected from the group consisting of: wind speed, precipitation, and combinations thereof.

15. The computer-readable program product of claim 11, wherein the program instructions, when executed, further cause the computer to:
use the improved forecast of the refractive index of the atmosphere to improve a forecast of the primary weather parameters.

16. The computer-readable program product of claim 15, wherein the program instructions, when executed, further cause the computer to:
obtain a historical error distribution for forecasts of the primary weather parameters by a primary one of the numerical weather models;
obtain a historical error distribution for the forecast of the refractive index of the atmosphere from the blended weather model; and
minimize a cost function to obtain optimized forecasts for the primary weather parameters that conform to the forecast of the refractive index of the atmosphere.

17. The computer-readable program product of claim 16, wherein the program instructions, when executed, further cause the computer to:
determine which one of the numerical weather models is most historically accurate using the GPS-RO measurements; and
use the most historically accurate numerical weather model as the primary numerical weather model.

18. The computer-readable program product of claim 13, wherein the program instructions, when executed, further cause the computer to:
run a numerical weather prediction model with the primary weather parameters forecast using the blended weather model as a boundary condition; and
obtain forecasts of the secondary weather parameters from the numerical weather prediction model.

19. The computer-readable program product of claim 18, wherein the numerical weather prediction model comprises a WRF model.

20. The computer-readable program product of claim 13, wherein the program instructions, when executed, further cause the computer to:
for a given one of the secondary weather parameters, select at least one of the primary weather parameters having a forecast error that impacts a forecast error of the given secondary weather parameter;
train a machine learning model which correlates the forecast error of the given secondary weather parameter and the forecast error of the at least one primary weather parameter using historical data;
estimate the forecast error of the at least one primary weather parameter; and
estimate the forecast error of the given secondary weather parameter using i) the trained machine learning model and ii) the estimated forecast error of the at least one primary weather parameter.
